(19) United States
(12) Patent Application Publication
(10) Pub. No.: US 2014/0376758 A1
(43) Pub. Date: Dec. 25, 2014

(54) UNIVERSAL PROTECTIVE HOUSING AND SOUND SYSTEM

(71) Applicants: Matthew Barcel, Johnson City, TN (US); Steven O'toole Dodson, Gresham, OR (US)

(72) Inventors: Matthew Barcel, Johnson City, TN (US); Steven O'toole Dodson, Gresham, OR (US)

(21) Appl. No.: 14/308,990

(22) Filed: Jun. 19, 2014

Related U.S. Application Data
(60) Provisional application No. 61/836,974, filed on Jun. 19, 2013.

(51) Int. Cl. H04R 1/02; H04R 1/44

(52) U.S. Cl. CPC H04R 1/02; H04R 1/44
USPC 381/334

(57) ABSTRACT

A protective housing and sound assembly and system are disclosed that allows a user to sync at least one electronic device that will be used while participating in water spots. The device generally comprises a protective housing, an electronic device connection or communications means, a latching mechanism and one or more speakers. Each of the elements of the device allow for a user to operate an electronic device without a concern for damaging the device while participating in water sports or other rugged sports.

### CLAIM OF PRIORITY

This application claims the benefit of and priority to U.S. Provisional Patent Application No. 61/836,974, filed Jun. 19, 2013, entitled Universal Surfboard Docking Station, which application is incorporated herein by reference in its entirety.

### FIELD OF THE INVENTION

The invention relates generally to protective housings for audio and video devices.

### BACKGROUND OF THE INVENTION

Watersports have increased in popularity as a recreational hobby over the decades. Currently, there is no reliable technology that will allow for the use of a personal and portable audio device, such as a music system, when exposed to water or dust or other rugged conditions. The emergence of lightweight and small portable audio players such as MP3 players and smartphones have made feasible the enjoyment of music while engaging in physical exercise, sporting events and other outdoor activities. Such audio and video playing devices are not constructed to be exposed to aquatic, dusty or other rugged environments. Furthermore, there is a need for housings that provide water resistant and/or shock resistant protection for audio and video devices.

Currently there are a number of solutions for an electronic device holder or case for water sports. Some of these solutions attempt to hold an electronic device on the body of the person, but these solutions fail to meet the needs of the industry because it restricts the movement while participating in water sports. Other solutions attempt to support an electronic device on the board, but these solutions are similarly unable to meet the needs of the industry because the holder or case does not prevent damage from use during water sports.

In one example in the prior art, Wood et al, in U.S. Pat. No. 7,400,917, discloses a case for a portable cellphone device having a housing with an externally exposed speaker integrated with the housing and adapted to receive the cellphone. The cellphone is electrically and mechanically connected to the housing such that external keys and a microphone can be connected to the internally housed cellphone. Apparently users may operate their cellphone in a hands-free mode while it is housed within the case and the housing appears to prevent water and dust from accumulating on the phone. The cellphone case of Wood '917 does not appear to disclose the uninterrupted playback of music and or video through its speaker and appears to be limited to enabling use of cellphones in rugged or wet environments.

Therefore, there currently exists a need in the industry for a protective housing device that allows a user to play music, make phone calls, and utilize other applications integrated on a portable electronic device while engaging in water sports or other activities.

### SUMMARY OF THE INVENTION

The various embodiments of the invention relate generally to a universal protective housing with a speaker system for use with audio and video devices. The speaker assembly system, in one example embodiment, is located on a surfboard or a paddleboard by the user. It would be desirable to have a device that attaches via a fastening means to water sport equipment, such as surfboards, jet skis, wake boards, kite boards, sail boats, wind surfing boards, paddleboards, kayaks and the like. Furthermore, it would also be desirable to have a device that incorporates waterproof speakers mounted onto the device. Still further, it would be desirable to have a device which is touch panel-compatible. The invention described herein advantageously fills the aforementioned deficiencies by providing a universal protective housing and sound system which provides a means to safely use a portable electronic device while participating in water sports. In a related embodiment, the holder is modified to work in dirty or dusty environments, such as for four-wheeling or on ATV vehicles or snowmobiles.

In one example embodiment, a protective housing and sound assembly for use with a portable electronic device is provided that includes a protective housing having a door thereon to facilitate insertion of the portable electronic device in a cavity formed by at least the housing, the housing including a door adapted to substantially protect an internally mounted portable electronic device mounted therein when the door is in a closed position. The housing assembly further includes at least one speaker assembly mounted on a side of the housing that is configured to receive signals from an internally mounted amplifier, wherein the amplifier is adapted to receive communications from the portable electronic device. A control interface mechanism is also provided that is disposed on the housing and adapted to facilitate control of the internally mounted portable electronic device. The housing and sound assembly also includes a mounting assembly adapted to securely mount the protective housing to a surface.

In a related embodiment, the control interface mechanism includes a capacitive touch screen panel (or with touch screen compatibility with an audio device screen) on the door of the housing adapted to control the electronic device mounted within the cavity. In related embodiment, the control interface mechanism includes a remote audio control pad on the housing adapted to control the electronic device mounted within the cavity. In yet another related embodiment, the housing and sound assembly further includes a nesting system adapted to secure the electronic device when disposed within the housing and configured to accommodate different sized portable electronic devices. In a related embodiment, the protective housing assembly includes an electrical connector in the housing configured to operatively and communicatively couple the portable electronic device to the speaker assembly.

In another example embodiment, a protective housing and sound assembly for use with a portable electronic device includes a housing having a door thereon to facilitate insertion of the portable electronic device in a cavity formed by the housing and the door, the housing and door adapted to substantially protect the portable electronic device mounted therein against water and dust when the door is in a closed position. The housing and sound assembly further includes at least one speaker assembly mounted on a side of the housing and configured to receive signals from an internally mounted amplifier, wherein the amplifier is adapted to receive communications from the portable electronic device. The housing and sound assembly further includes a control interface mechanism disposed on the housing and adapted to facilitate control of the internally mounted electronic device. Further included is a heat dissipation assembly adapted to cool the portable electronic device disposed within the housing, the heat dissipation system including a heat sink member disposed beneath the cavity. In a related embodiment, the speaker assembly is comprised of a water repelling system, the water repelling system including a speaker grill formed from a plurality of elongate members adapted to form a plurality of large openings around a speaker assembly surface to facilitate free flow water away from the speaker assembly.

In yet another example embodiment, a housing and sound assembly for use with a portable electronic device includes a housing having a door thereon to facilitate insertion of the portable electronic device in a cavity formed by the housing and the door, the housing and door adapted to substantially protect the electronic device mounted therein against water and dust when the door is in a closed position. The housing and sound assembly including at least one speaker assembly mounted on a side of the housing and configured to receive signals from an internally mounted amplifier, wherein the amplifier is adapted to receive communications from the electronic device. There is further provided a control interface mechanism disposed on the housing and adapted to facilitate control of the internally mounted electronic device. The housing and sound assembly further include a water repelling system which includes a speaker grill formed from a plurality of elongate members adapted to form a plurality of openings around the at least one speaker assembly to facilitate free flow water away from the speaker assembly.

In a related embodiment, the housing and sound assembly further includes a mounting assembly which includes at least one hole in bottom of the housing adapted to be coupled with a head on a mounting pad, the mounting pad configured to be attached to a surface on which the protective housing assembly is to be placed by a user. In a related embodiment, the housing and sound assembly further includes a mounting assembly which includes at least a mounting docking station adapted to be attached to a surface on which the protective housing assembly is to be placed by a user, wherein the housing is adapted to be mounted on the docking station.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF THE DRAWINGS

Other important objects and advantages of the present invention will be apparent from the following detailed description of the invention taken in connection with the accompanying drawings in which:

FIG. 1A illustrates a perspective view of a protective housing and sound system according to the invention in a closed configuration;

FIG. 1B illustrates a perspective view of the protective housing and sound system according to the invention in an open configuration ready to receive an audio device;

FIG. 1C illustrates a side view the protective housing and sound system according to the invention in another open configuration;

FIG. 1D illustrates a side cutaway internal view the protective housing and sound system according to the invention;

FIG. 1E illustrates a side cutaway partial internal view an external remote control button operation and an internal nesting system of the sound system configured to receive smartphones or other audio devices of varying geometries according to the invention;

FIG. 2A illustrates a side and internal view of the protective housing and sound system dissipating heat away from the sound system according to the invention;

FIG. 2B illustrates a pictorial of the heat dissipation system of the protective housing and sound system according to the invention;

FIG. 3A illustrates a perspective view a speaker mounted within the protective housing and sound system according to the invention;

FIG. 3B illustrates a side cutaway view of one speaker assembly repelling water away from the sound system according to the invention;

FIGS. 4A-4D illustrate various views of a mounting system of the protective housing of the invention;

FIG. 5 illustrates a system diagram of an example embodiment of the sound system of the invention;

FIG. 6 illustrates a perspective view of another example embodiment of the protective housing and sound system of the invention in a closed configuration;

FIG. 7 illustrates a perspective view of another example embodiment of the protective housing and sound system of the invention wherein a main portion of the housing is separated from a mounting base;

FIG. 8 illustrates a perspective view of the protective housing of the invention in an open configuration ready to receive an audio device; and

FIG. 9 illustrates a side view of the protective housing of the invention in an open configuration ready to receive an audio device.

### DETAILED DESCRIPTION OF THE INVENTION

Following below are more detailed descriptions of various embodiments of the protective housing and sound system invention described herein. In particular, the various embodiments disclosed herein describe a waterproof, heat dissipating and shock resistant sound system configured to house an audio or video device, such as an MP3 player or a smartphone, for users that are active in water or outdoor activities. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

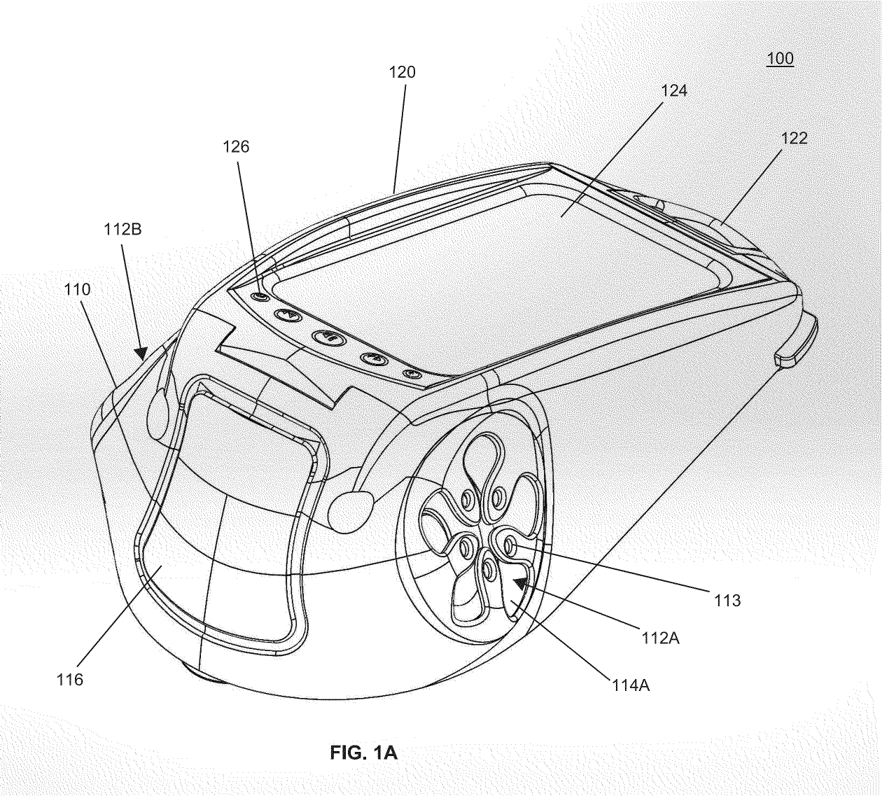

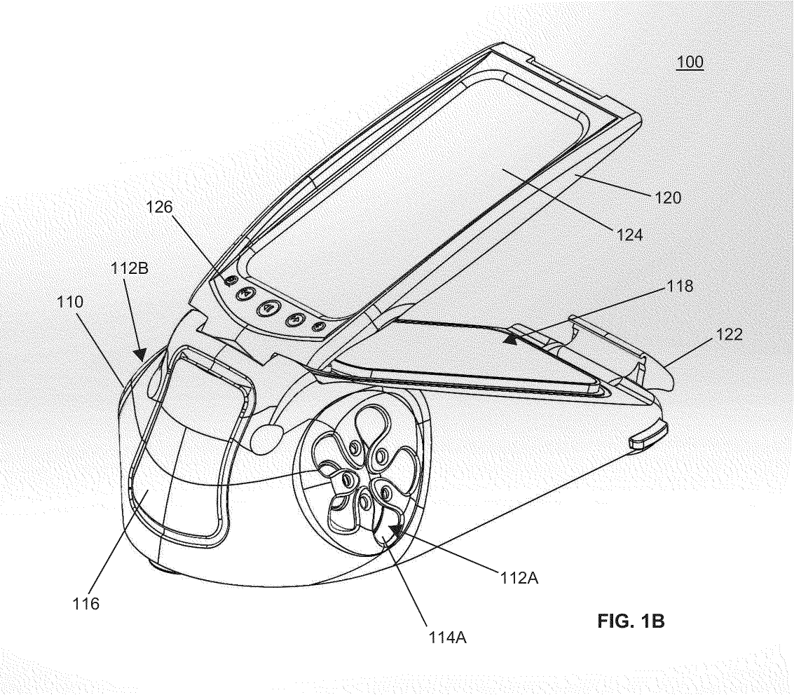

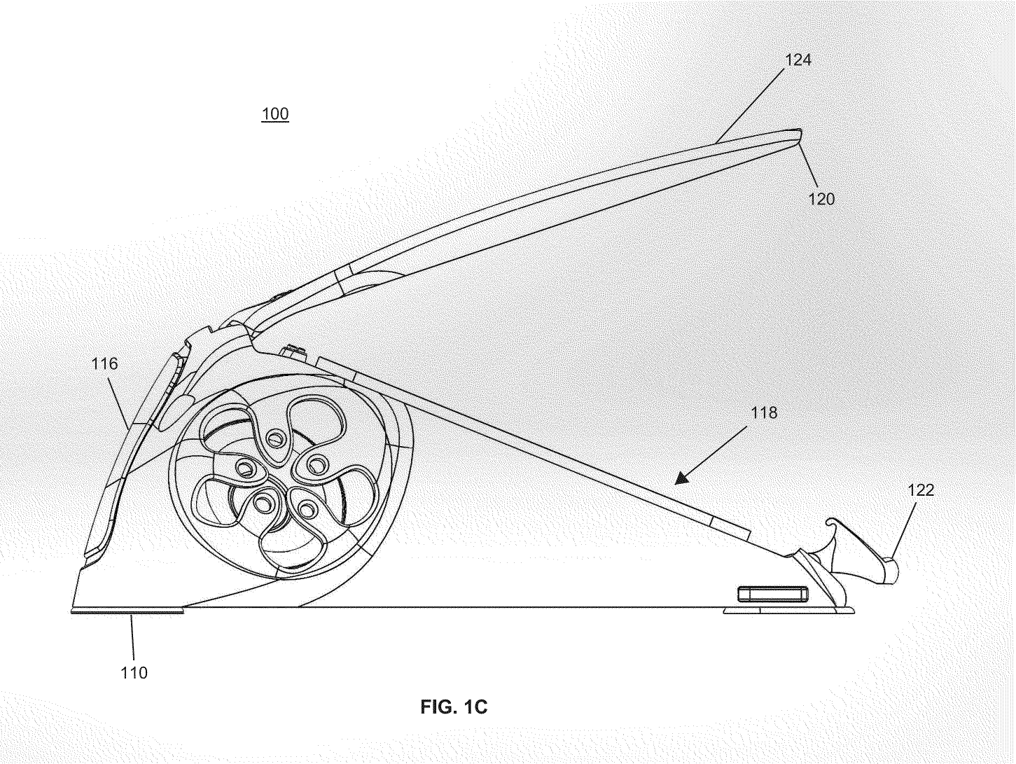

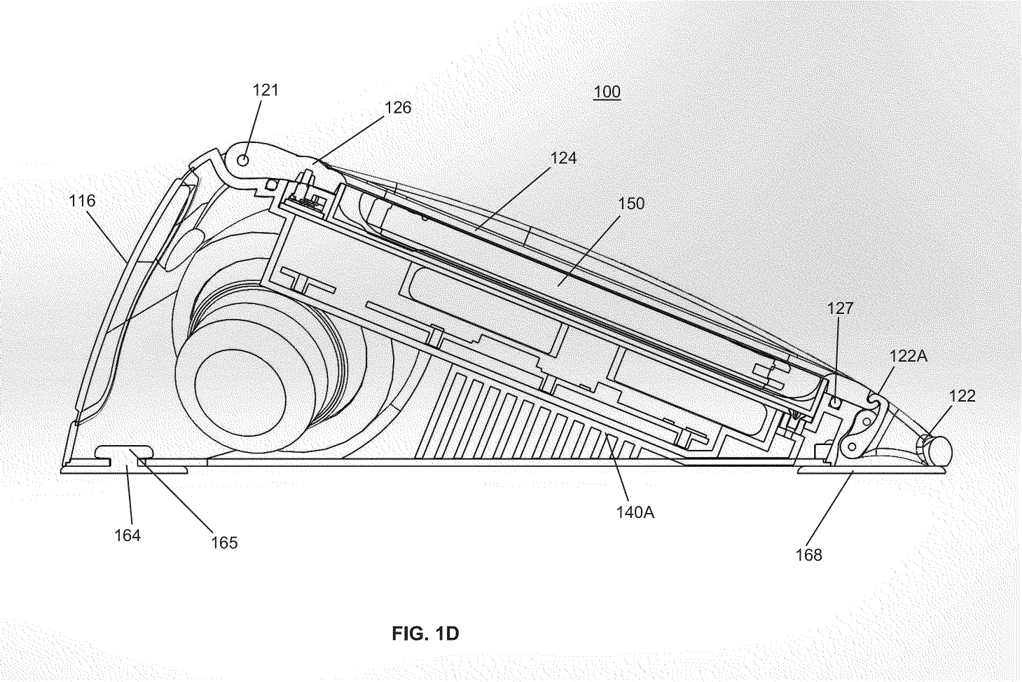

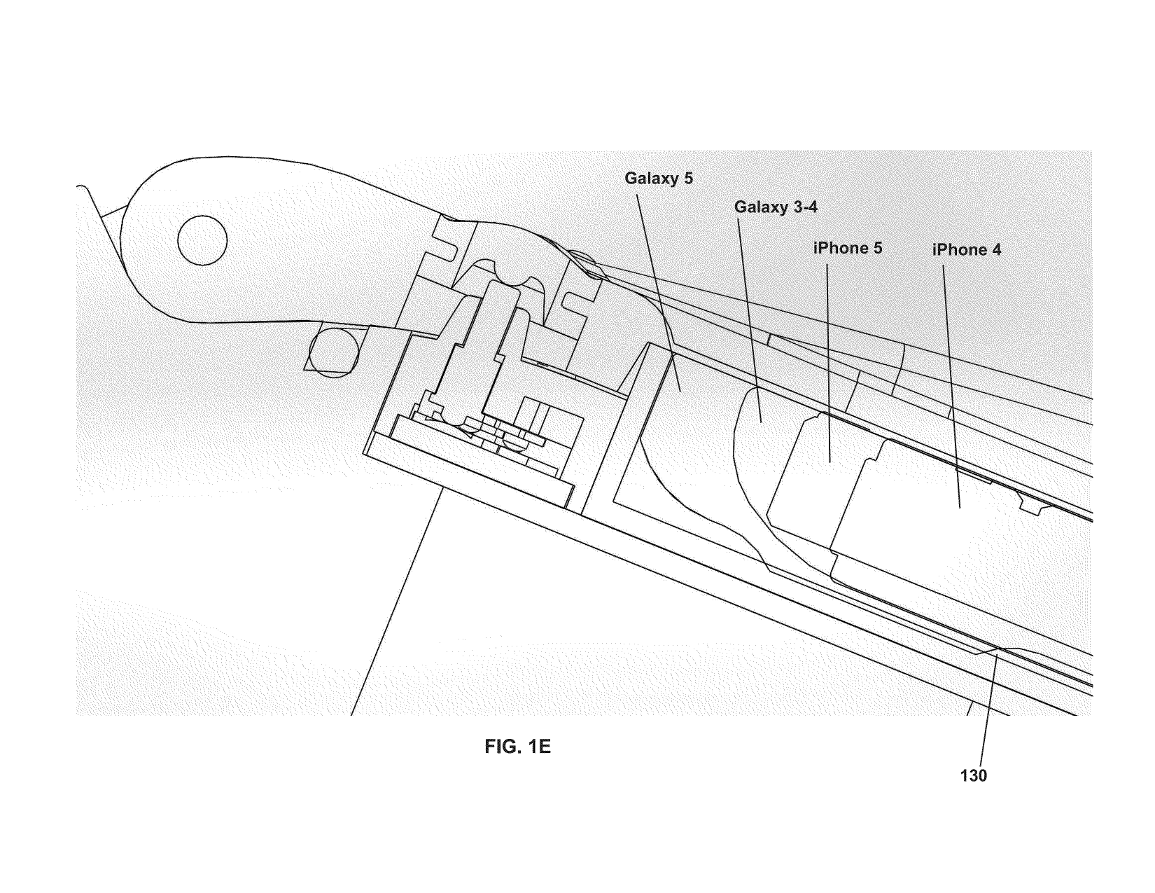

Referring now to the Figures, FIGS. 1A-1E illustrate an example embodiment of a protective housing and sound system 100. In particular, FIGS. 1A-1B illustrate perspective views of protective housing and sound system 100 according to the invention in closed and open configurations. Protective sound system 100 is comprised of a housing 110 with a door or lid 120 and latching mechanism 122. Housing 110 further includes a set of speaker ports 112A and 112B having speaker guard or grill 113 (with elongate members 113C), with speakers or drivers 114A and 114B located therein. Housing 110 also includes a passive bass port 116 at one end near the speakers or drivers. Generally, a passive bass port such as passive bass port 116 is a methodology of resonating and amplifying bass frequencies without an active base speaker by way of using a flexibly attached panel. Bass frequencies are usually present but do not resonate well in smaller drivers or speakers. Hence a passive bass port improves projection of these lower frequencies.

Once door 120 is opened via latch 122 there is exposed an internal compartment or cavity 118 adapted for accommodating an audio device such as, but not limited to, a smartphone or MP3 player or mini-tablet PC. Door 120, in this example embodiment, includes a transparent panel 124 and a control keypad 126 configured to control the audio device once it is located within protective housing and sound system 100. FIG. 1C illustrates a side view of the outside of housing 110 of the protective housing and sound system in an open configuration according to the invention.

Referring now to FIGS. 1D-1E there is illustrated a side cutaway internal view of the protective housing and sound system 100 and the internal components according to the invention. In this example embodiment, housing 110 is formed of any material resistant to impact and a wide range of temperatures and has door frame 120 formed primarily of the same material, which is hinged at hinge 121 for ease of opening. In this example embodiment, lid 120 also protrudes above housing 110 to provide additional impact protection. In a related embodiment door 120 is a solid piece of material without center panel 124. Door 120 is released and locked by a cam latch 122A of latching mechanism 122 and provides a watertight enclosure with aid from a compression gasket 127 disposed around the opening of door 120.

In this example embodiment, door 120 includes a capacitive touch screen cover or center panel 124 which is compatible with most capacitive displays for direct control of the audio or video of electronic device 150 housed by protective sound system 100. In a related embodiment, center panel 124 can be plain and the user uses external remote controls 126 located at the top of door 120 to control device 150 disposed within housing 110. In this example embodiment, a heat sink 140A is further included that is disposed underneath device 150 to help dissipate heat away from device 150.

FIG. 1E illustrates a side cutaway partial internal view of an external remote control button operation and an internal nesting system 130 of sound system 100 configured to receive an electronic device 150, such as a smartphone or other audio devices of varying geometries, according to the invention. In particular, nesting system 130 is configurable to receive various smartphones of various sizes including various generations of Apple® and Samsung® smartphones. In this example embodiment, a plurality of nests 132 are provided which are a series of silicone (or any other flexible elastomeric material suitable for this type of application) trays that cradle each type of the audio device within protective housing 110 and cavity or compartment 118. Each nest or tray or adapter 132 will vary in thickness and internal shape to adjust for varying audio device sizes so as to keep the device in a proper operating position and orientation (screen against screen) and reduce potential device movement within protective housing 110 during use.

FIG. 1E also illustrates an external remote control button configuration in which the remote control button actuates a switch on a printed circuit board. In particular, when the external button is pushed down by the user the external button pad makes contact with an elongate internal button member which in turn is in contact with the switch on the printed circuit board (PCB). The internal button member can be a transparent member that is in contact with an LED on the PCB so as to also transmit a light (similar to a lightpipe) up to the external button pad to indicate an “ON” position. Other similar arrangements are also possible that are known in the art that would accomplish the same result.

In a related embodiment, each nest or adapter includes a frame that fits around the outer perimeter of the audio device so as to not block contact between the back of the audio device with the heat sink. Additional frame material may be added to the back, sides or end of the frame to locate the audio device close to the keypad and capacitive touch screen surface. In a related embodiment, cavity 118 is configurable to adjust (with moveable partitions) or accommodate the various sized audio devices. The nests or adapters can also be made from other materials compatible with housing system 100 that secure the audio device and assist in heat dissipation or cooling and to reduce vibration while the sound system is in use.

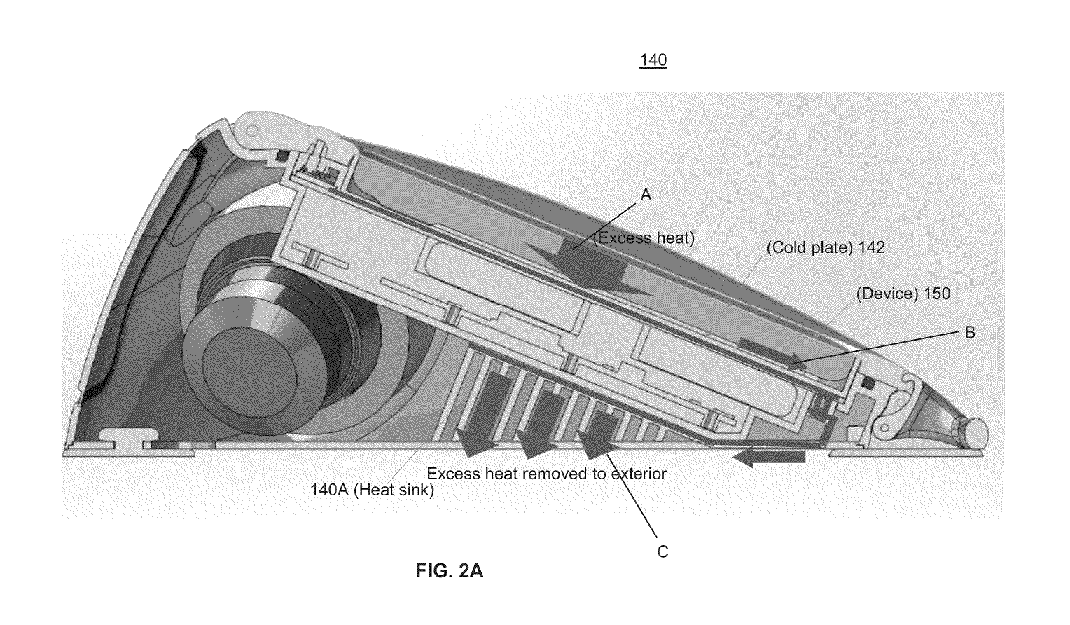

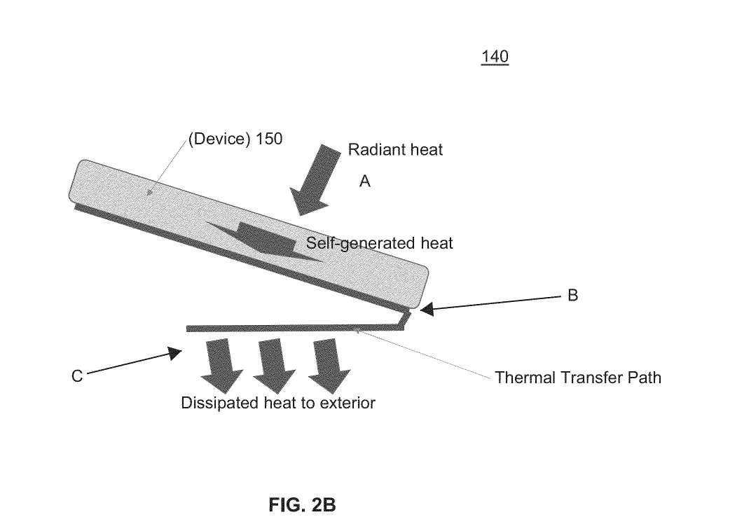

Another novel aspect of the various embodiments of the protective housing sound systems taught herein is the heat dissipation system for heat generated by operation of electronic device or other memory storage device 150 as well as external heat (such as sunlight) directed at a top of housing 110 and center panel 124. In one example embodiment, FIG. 2A illustrates a side and internal view the protective housing and sound system 100 dissipating heat away from the sound system. FIG. 2B illustrates a pictorial of a heat dissipation system 140 of the protective housing and sound system and the path for directing the heat away from device 150 and housing 110.

In this example, excess heat (arrow A) produced in the electronic/audio device and within the protective housing from absorbed solar radiation, along with heat generated by the audio device itself is channeled through a cooling plate 142 (arrow B) to a heat-sink 140A, where the heat is dissipated with the fins of the heat sink directing the heat (arrows C) to the bottom of housing 110 so as to exchange warm air with cooler air or water from the nearby aquatic activity. In a related embodiment, a cooling shell or cooling perimeter plate or plates can be used to cool the device instead of a cooling plate over the audio device. Other cooling configurations for the heat sink are possible as well as other cooling arrangements can also be incorporated into system 100 including, but not limited to, Peltier thermoelectric cooling devices.

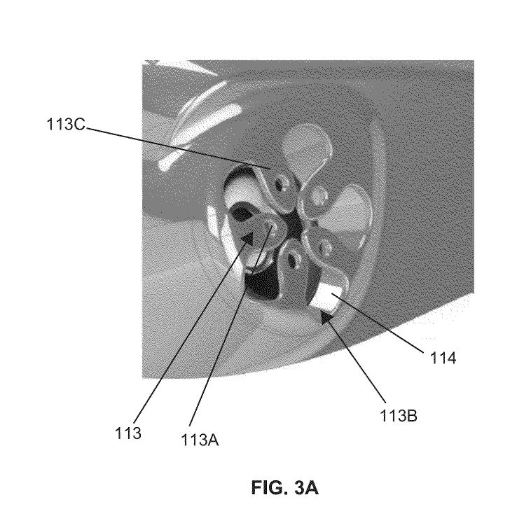

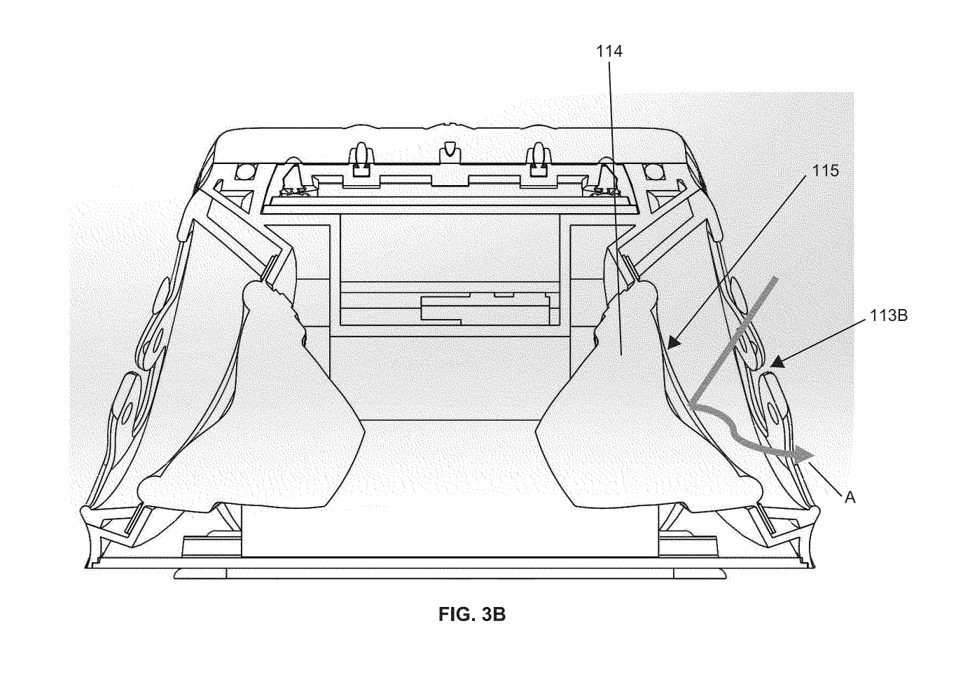

Another novel aspect of the various embodiments of the protective housing sound systems taught herein is the water repelling or water shedding system of the speaker and speaker ports to promote quick sound recovery and protect the driver during operation. Referring now to FIGS. 3A-3B there is illustrated an example embodiment of a perspective view a speaker assembly 114 mounted within port 112 of housing 110 and a side cutaway view of one speaker 114 repelling water away from sound system 100 according to the invention, respectively. In this example embodiment, speaker guard or grill 113 is comprised of a plurality of elongate members 113C that not only provide protection for a face of speaker assembly 114 but also promote air flow and water drainage along with large openings 113B.

In this example embodiment, elongate members 113C include holes 113A that also promote air flow through port 112. Openings 113B are intentionally larger to improve the grill/free-air ratio, since this type of grill does not rely on being perforated like a mesh or grid cover as with most speakers. A major benefit of the “open grill” arrangement disclosed herein is that water is not trapped by surface tension or capillary action by a typical mesh grill, which causes distortion of sound and degradation of audio quality. The speaker grill design taught herein eliminates this problem. Note the water is “actively” repelled (arrow A) from the surface of the driver via a super-hydrophobic coating 115 that is disposed thereon to cause repelling or shedding of water and through large openings 1138 that allow water to freely flow water away from the driver surface. Super-hydrophobic coatings increase the contact angle of liquids on the coated surface. In our example embodiment, the coating used, which is based on nanotube technology and nanotechnology, traps a layer of air on the surface of the object in a micro network of fibers. The coating causes an almost imperceptibly thin layer of air to form on top of a surface that repels water.

To further assist housing system 100 with water shedding, lid 120 (and angle of display face) and upper surface of housing 110 is angled downwards as a means to promote rapid removal of water from the capacitive touch screen to improve functionality and overall removal of water from the unit. In a related embodiment, a super-hydrophobic coating is added onto the capacitive touch compatible window, as water on the user's finger increases the capacitive “footprint” (area) of the finger, thus confusing the audio control system.

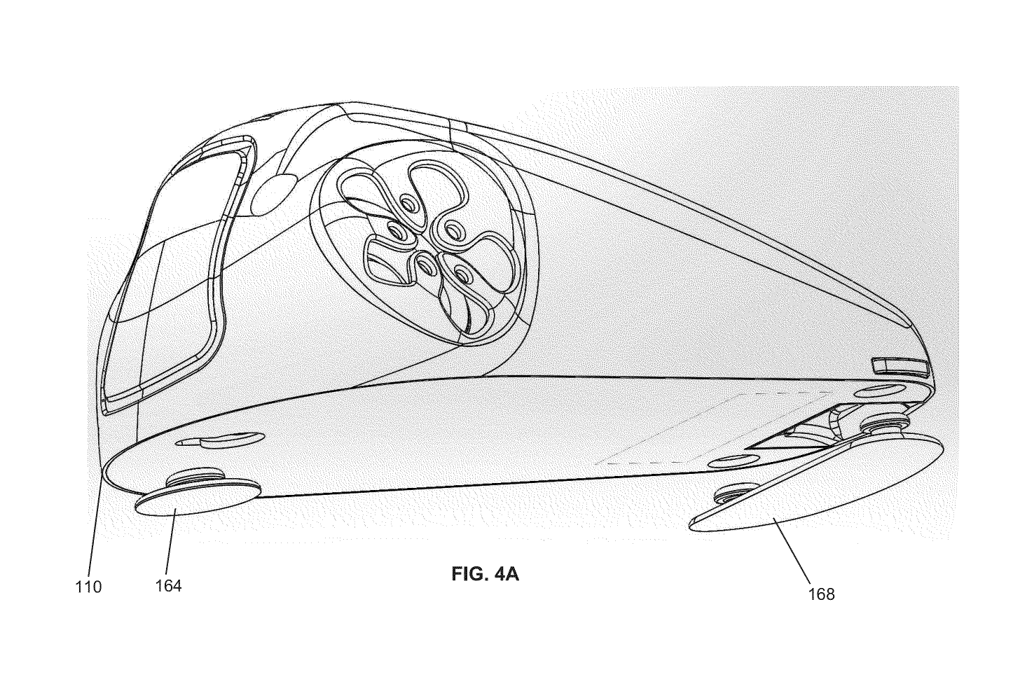

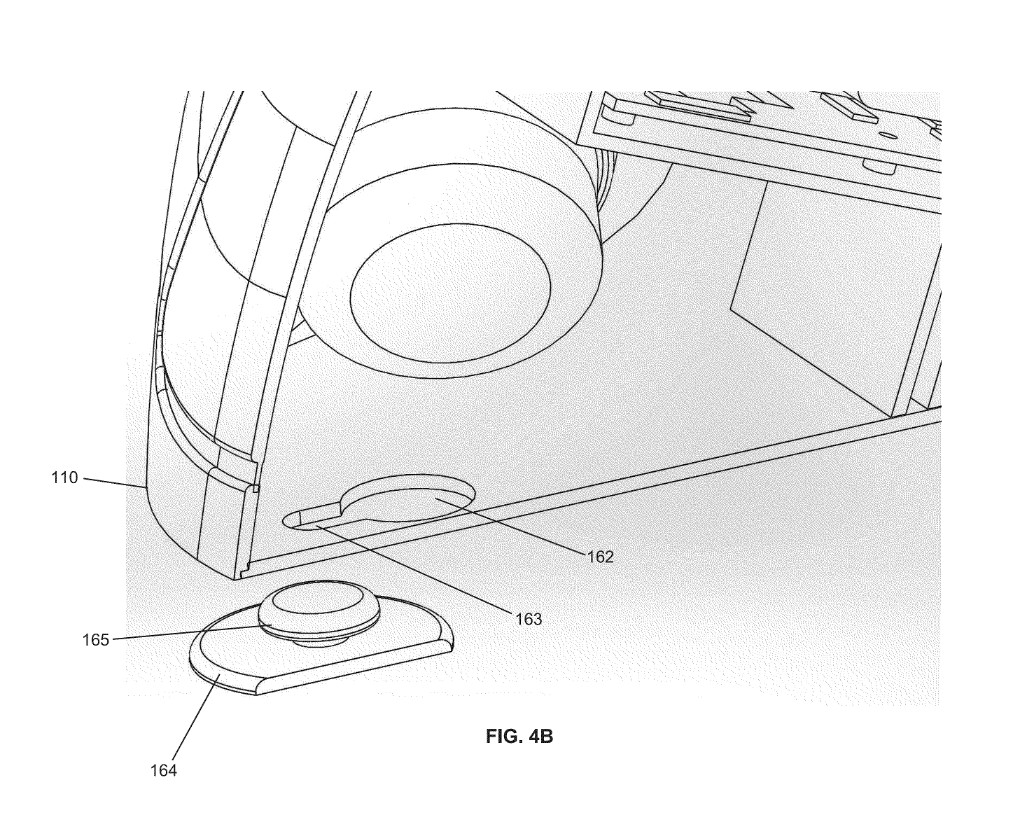

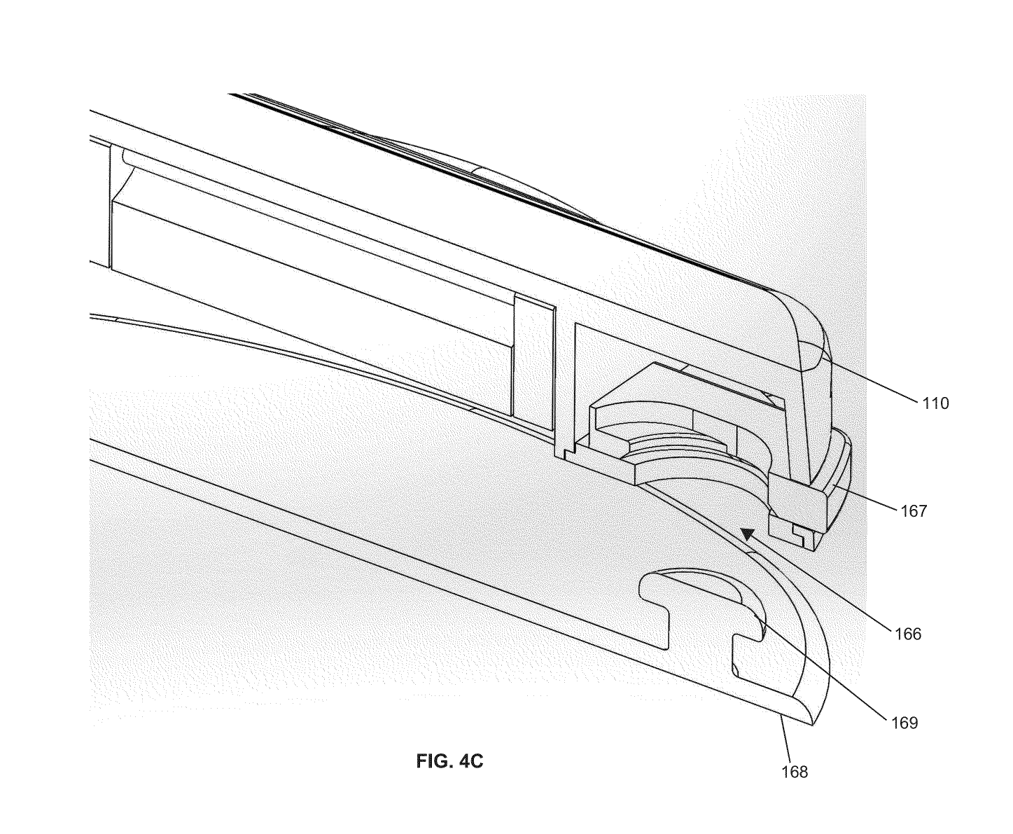

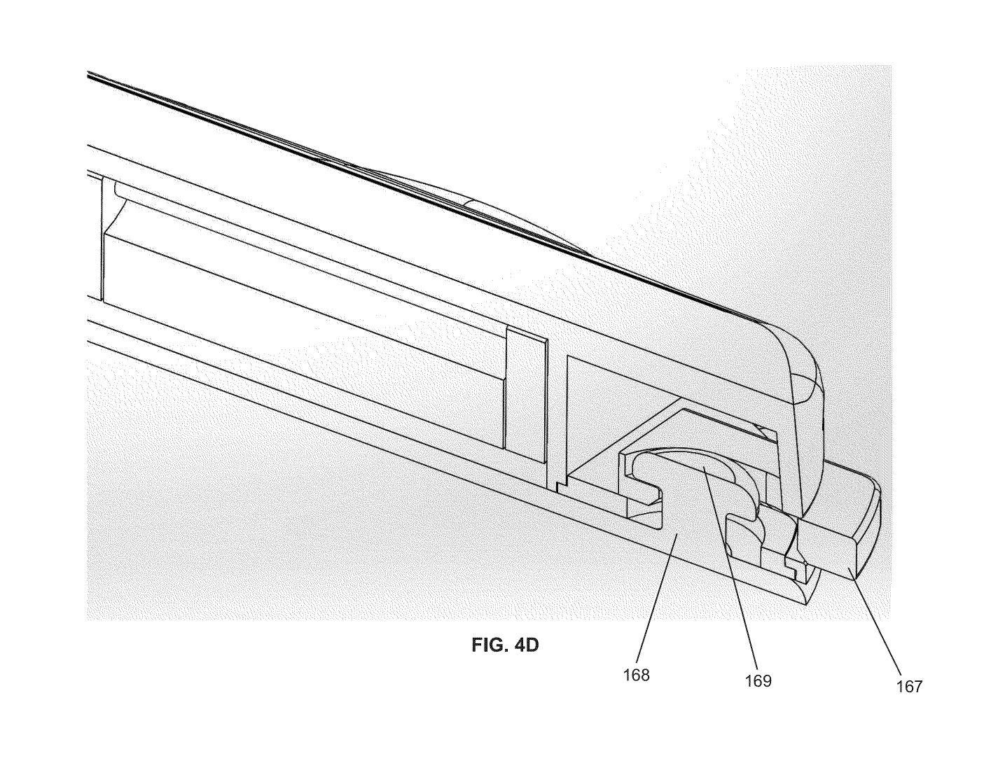

Another novel aspect of the various embodiments of the protective housing sound systems taught herein is a mounting system for the protective housing sound system for surfaces such as surfboards and paddleboards. FIGS. 4A-4D illustrate various views of an example embodiment of a mounting system 160 of protective housing system 110 of the invention. In this example embodiment, mounting system 160 includes at least one hole or aperture 162 located in a base of housing 110 that is coupled to a mounting pad 164 in a front portion of housing 110. Hole 162 includes a slot 163 that mates with (or receives) a head 165 of mounting pad 164 as it is slid there through. In this example embodiment, the front mounting system includes two holes 162 and two mounting pads but is not limited to such an arrangement. In a related embodiment, a single hole 162 and mounting pad 164 is provided. In another related embodiment, a single elongate slot 162 is provided to mate or engage with an elongate mounting pad 164.

Referring to FIGS. 4C and 4D, on a rear portion of the base of housing 110 is located two other holes 166 each with a locking member 167 that is coupled to an elongate mounting pad 168 with two heads 169 for engaging holes 166. Once head 169 is inserted into hole 166 and fully engaged, locking member 167 slides into place to lock head 169 with hole 166, thereby locking housing 110 onto the desired surface. In a related example embodiment, the rear mounting system includes two holes 166 and two mounting pads. In another related embodiment, single hole 166 and mounting pad 168 is also operative to anchor housing 110 onto a surface. In yet another related embodiment, a single elongate slot 166 is provided to mate or engage with an elongate mounting pad 164. Variations to the mounting pairs and schemes are easily envisioned by one skilled in the art and are not necessarily limited to those described herein.

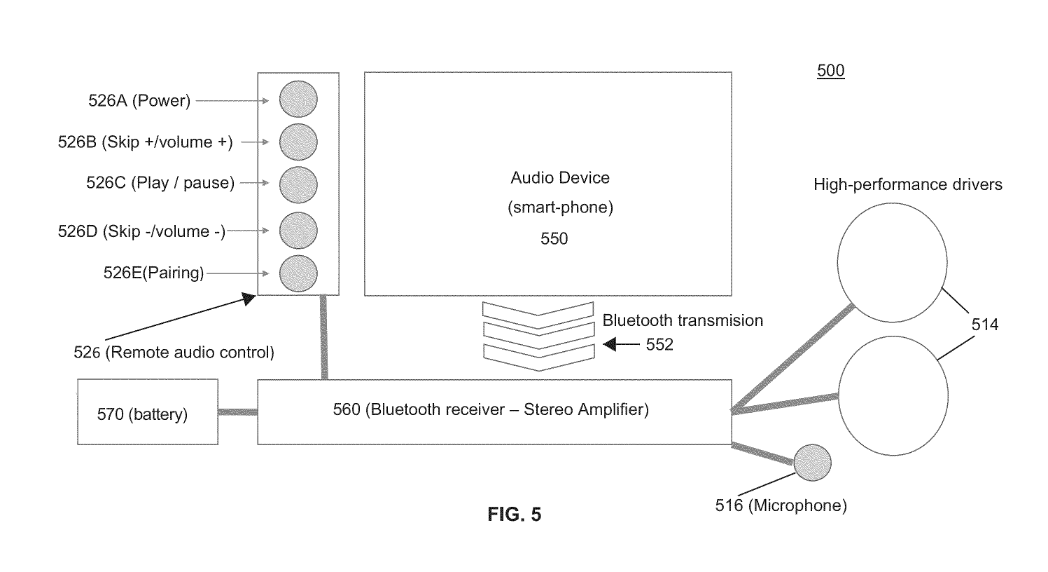

Referring now to FIG. 5, there is illustrated a system diagram of an example embodiment of a sound system 500 of the protective housing system described herein. In particular, system 500 includes a remote audio control panel or keypad 526 for controlling an audio device 550 that is mounted within housing system 100. Remote control keypad 526 includes control buttons or pads 526A for power, 526B and 526D for skip/volume control and 526E for pairing control. Whereas the control buttons are also accessible when door 120 is both open (inside) and closed (outside the protective enclosure) by way of flexible membrane buttons on the door, the user does not have to close the lid or case in order for the control buttons to be operative. This approach also eliminates the need to have electrical connections through the hinge of the door. In this embodiment, keypad 526 controls the audio device through bi-directional Bluetooth signals. In a related embodiment, keypad 526 has the capability to control audio device through wired control through a 4-pin headphone jack. In a related embodiment, LED indicators are integrated with the remote control for improved visibility.

Remote control 526 is electrically coupled to a Bluetooth-enabled stereo amplifier 560 that is electrically coupled to a set of speakers or high performance drivers 514. The system is energized by a battery 570 (in this example, one or more 3.7 volt batteries) which is chargeable by an external AC or DC source. In operation, an audio device 550 is inserted into housing 110 and secured in nesting system 130. A Bluetooth transmission signal 552 from device 550 is signal processed by receiver and amplifier 560 which thereby transmits a signal to drivers 514. Device 550 may either be controlled from remote control 526 or via the capacitive touch screen or touch compatible cover 124 of door 120 disclosed above. In a related embodiment, sound system 500 is configurable to include a connector adapted for charging and/or powering audio device 550 from battery 570 either external to housing 110 or while device 550 is in nesting system 130. In a related embodiment, a waterproof microphone 516 is included in sound system 500 to enable the user to use a smartphone connected to the sound system to make or receive calls or receive and respond to voice commands through voice recognition software. Microphone 516 is electrically coupled to amplifier 560 in this example embodiment.

In related embodiments, speakers 114 can be used while lid 120 is open. In another embodiment, the audio device is chargeable through a passive charging system in the sound systems described herein. In yet another embodiment, the audio device communicates via Bluetooth with any of the sound systems disclosed herein from outside of the housing and need not be in the cradle, nest or cavity. In yet another embodiment, memory storage is added to the sound system to facilitate storage of music. In yet another embodiment, a small video LCD screen is added to allow for playing of videos with the protective sound systems described herein. In yet another embodiment, Wi-Fi capabilities are integrated into the system such that the sound system can be used in and around a home with Wi-Fi.

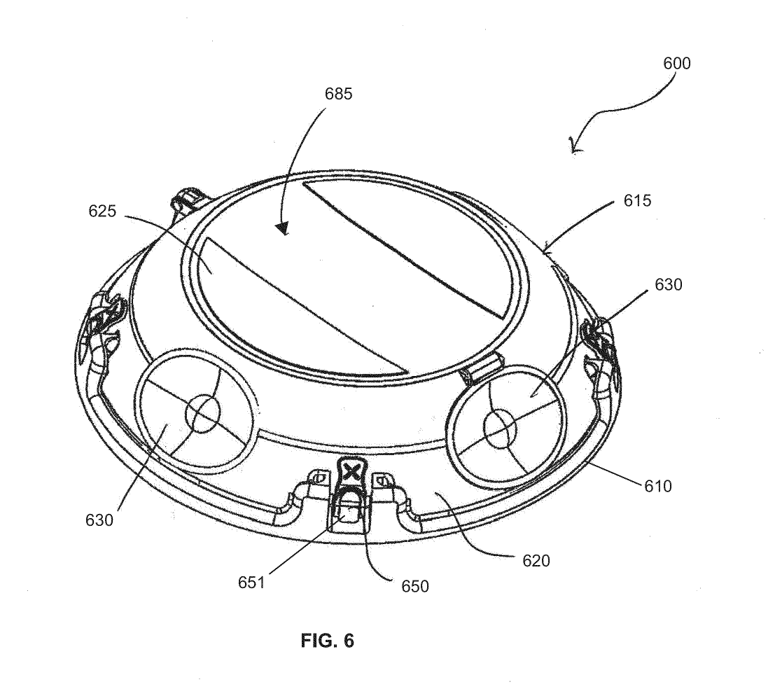

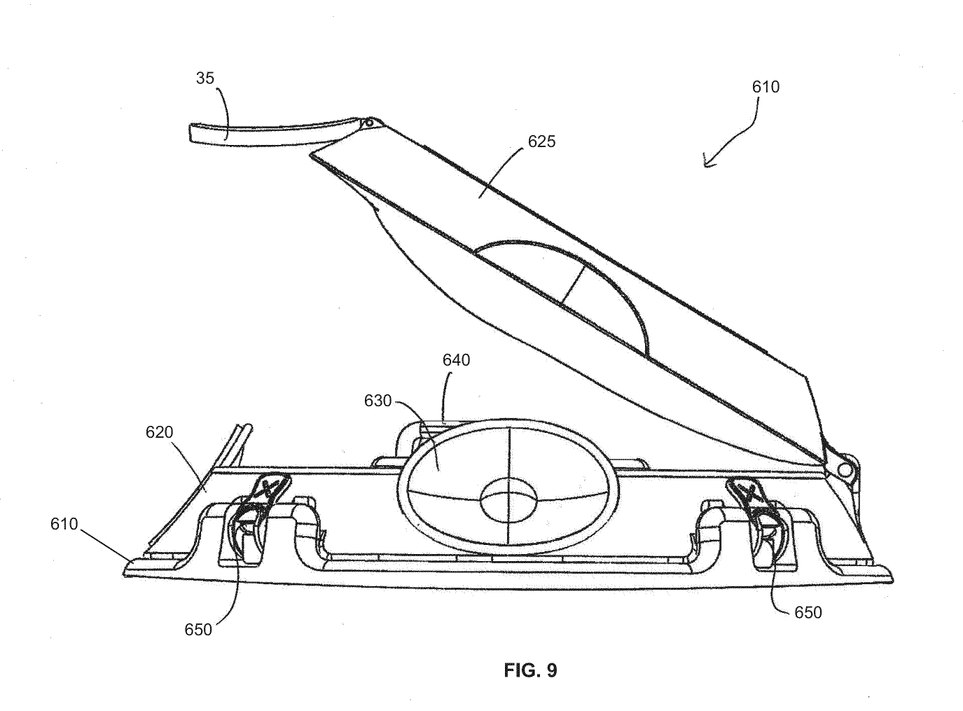

Referring now to FIGS. 6-9, in another example embodiment of a protective housing sound system there is provided a sound system 600, for a portable electronic device, which includes a docking station 610 configured to be mounted on a surface of surfboard, paddleboard, boat or any other activity device or structure. In this example embodiment, protective sound system 600 is further comprised of an outer shell 615 and a base 620 which are collectively coupled to docking station 610. Outer shell 615 and base 620 include speakers 630, a fastening system 650, and an electronic device securing or fastening means 640 under shell or cover 615. When housing sound system 600 is in a closed position, it provides a water-resistant and dust-resistant characteristic capability.

Outer shell 615 generally comprises a lid 625 and a base 620 that are made of a water-resistant durable material, such as a hard plastic or silicon-based material. In at least this particular embodiment, lid 625 and shell 615 provide a mating section proximate an outer rim to give the internal cavity (formed by base 620 and lid 625) protection from the outer environmental conditions when in use. In a related embodiment, the mating section would generally include mechanisms well known in the art such as a rubber gasket and the like. Lid 625 and base 620 are also secured by a fastening mean 650 such as a latch 651. Lid 625 includes a capacitive touch compatible window or panel through which the user can manipulate an audio device's capacitive touch display to allow the user to use the encased electronic devices when engaging in water sports or other activities. In a related embodiment, lid 625 may also include a capacitive touch panel display 655 for control of the enclosed audio device.

In this example embodiment, speaker(s) 630 provides for audible expression or transmission of the electronic devices attached within system 600. In this example embodiment, speaker 630 includes a water-resistant coating along the external surface. In an alternative embodiment, speaker 630 is made from a material that is non-porous and will not allow the influx of water to the internal components. In this example embodiment, speaker 630 also includes a sealing ring 635, which allows the external edge of speaker 630 from being infiltrated with water when docking station 610 is in a closed position for use.

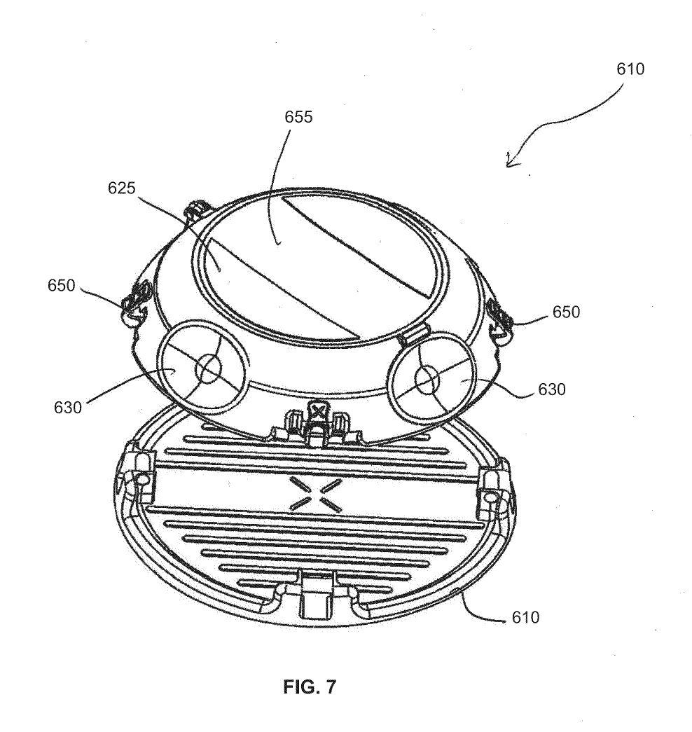

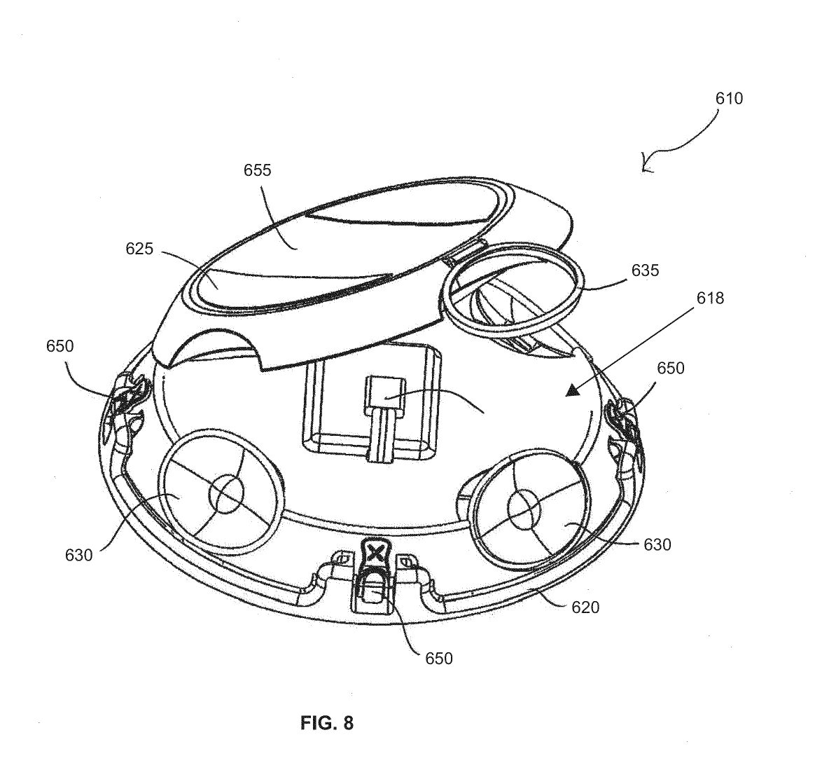

As best illustrated in FIGS. 7 and 8, system 600 and shell 615 has an internal cavity 618 that can house several electronic devices. As best illustrated in FIG. 8, internal cavity 618 may comprise an electronic device communication means 660, fastened by a strap or fastener 640, which may comprise technologies such as a USB port (or fire wire or other configurations) that allows a user to connect a wide variety of electronic devices to system 600. Alternatively, device 660 simply communicates via Bluetooth with the sound components within system 600.

In this example embodiment, docketing station 610 of system 600 includes an adhesive for adhering or attaching the docking station onto a surface and remain fastened while on the surface of water sport equipment, such as a surfboard or paddleboard. In an alternative embodiment, docking station 610 latches onto sports equipment with a mounting apparatus that allows the docking station to be removeably attached to sports equipment. In yet another embodiment, station 610 is configured for dirty, muddy or dusty or rugged sports and environments. In this example embodiment, protective housing and sound system 600 is powered through an encased battery and is securely connected through a latching mechanism.

Optional features of the various example embodiments of the invention can include a surf app (downloadable software) for the portable electronic device that is docked as well as solar panels to power the protective housing and sound system and/or charge the portable electronic device (housed internally or while connected externally). In other embodiments, system 100 and system 600 also include a corresponding surf app available for a smartphone or other portable electronic or memory storage device, which will connect multiple protective sound system users and allow for the sharing of music playlists located on a variety of online music playing websites. In yet another example embodiment, system 100 and system 600 are configurable to receive other electronic devices including, but not limited to, a camera, a GPS, a basic cellphone or smartphone or tablet PC. In the case of the camera, system 100 and system 600 provides means for mounting inside (with a transparent lens on the shell body) or mount outside the shell body or housing body.

In other related embodiments, although system 100 and system 600 are buoyant by nature of their current respective designs, each system can be further configured to include external flotation accessories coupled on the outside should the sound systems become separated from the surfboard or paddleboard surface. In one example, a brightly colored elastic band coupled to the sound system and wrapped around the board provides further assurance that the sound systems stay with the user.

The following patents and publications are herein incorporated by reference in their entireties: U.S. Pat. Nos. 7,400,917; 7,535,799; 7,755,975; 8,113,346; 8,457,340; 8,599,547; and U.S. Publication Nos. 2012/0308064 and 2012/0316798.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A protective housing and sound assembly for use with a portable electronic device, comprising:
a protective housing having a door thereon to facilitate insertion of the portable electronic device in a cavity formed by at least the housing, the housing including a door adapted to substantially protect an internally mounted portable electronic device mounted therein when the door is in a closed position;
at least one speaker assembly mounted on a side of the housing and configured to receive signals from an internally mounted amplifier, wherein the amplifier is adapted to receive communications from the portable electronic device;
a control interface mechanism disposed on the housing and adapted to facilitate control of the internally mounted portable electronic device; and
a mounting assembly adapted to securely mount the protective housing to a surface.

2. The protective housing and sound assembly of claim 1, wherein the control interface mechanism is comprised of a capacitive touch screen compatible panel on the door of the housing adapted to control the electronic device mounted within the cavity.

3. The protective housing assembly of claim 1, wherein the control interface mechanism is comprised of a remote audio control pad on the housing adapted to control the electronic device mounted within the cavity.

4. The protective housing assembly device of the claim 1, further comprising a nesting system adapted to secure the electronic device when disposed within the housing and configured to accommodate different sized portable electronic devices.

5. The protective housing assembly of claim 1, further comprising a heat dissipation system disposed within the housing, the heat dissipation system including a heat sink member disposed beneath the cavity.

6. The protective housing of claim 5, wherein the heat dissipation system further includes a cooling plate disposed above the portable electronic device when the electronic device is located within the cavity of the housing.

7. The protective housing of claim 1, wherein the speaker assembly is comprised of a water repelling system, wherein the water repelling system includes a speaker grill formed from a plurality of elongate members adapted to form a plurality of large openings around a speaker assembly surface to facilitate free flow water away from the speaker assembly.

8. The protective housing of claim 7, wherein the water repelling system also includes a super hydrophobic coating on a surface of the speaker assembly.

9. The protective housing of claim 1, wherein the protective housing assembly includes an electrical connector in the housing configured to operatively couple the portable electronic device to the speaker assembly.

10. A protective housing and sound assembly for use with a portable electronic device, comprising:
a housing having a door thereon to facilitate insertion of the portable electronic device in a cavity formed by the housing and the door, the housing and door adapted to substantially protect the portable electronic device mounted therein against water and dust when the door is in a closed position;
at least one speaker assembly mounted on a side of the housing and configured to receive signals from an internally mounted amplifier, wherein the amplifier is adapted to receive communications from the portable electronic device;
a control interface mechanism disposed on the housing and adapted to facilitate control of the internally mounted electronic device; and
a heat dissipation assembly adapted to cool the portable electronic device disposed within the housing, the heat dissipation system including a heat sink member disposed beneath the cavity.

11. The protective housing assembly of claim 10, wherein the heat dissipation assembly further includes a cooling plate disposed about the electronic device when the device is located within the cavity of the housing.

12. The protective housing assembly of claim 10, a mounting assembly adapted to securely mount the housing to a surface.

13. The protective housing assembly of claim 10, wherein the control interface mechanism is comprised of a capacitive touch screen compatible panel on the door of the housing adapted to control the electronic device mounted within the cavity.

14. The protective housing assembly of claim 10, wherein the speaker assembly is comprised of a water repelling system, the water repelling system including a speaker grill formed from a plurality of elongate members adapted to form a plurality of large openings around a speaker assembly surface to facilitate free flow water away from the speaker assembly.

15. The protective housing assembly of claim 10, further comprising a nesting system adapted to secure portable electronic device and configured to accommodate different sized electronic devices.

16. A housing and sound assembly for use with a portable electronic device, comprising:
a housing having a door thereon to facilitate insertion of the portable electronic device in a cavity formed by the housing and the door, the housing and door adapted to substantially protect the electronic device mounted therein against water and dust when the door is in a closed position;
at least one speaker assembly mounted on a side of the housing and configured to receive signals from an internally mounted amplifier, wherein the amplifier is adapted to receive communications from the electronic device;
a control interface mechanism disposed on the housing and adapted to facilitate control of the internally mounted electronic device; and
a water repelling system which includes a speaker grill formed from a plurality of elongate members adapted to form a plurality of openings around the at least one speaker assembly to facilitate free flow water away from the speaker assembly.

17. The protective housing assembly of claim 16, further comprising a heat dissipation assembly adapted to cool the electronic device disposed within the housing, the heat dissipation system including a heat sink member disposed beneath the electronic device.

18. The protective housing assembly of claim 16, further comprising a nesting system adapted to secure electronic device within the cavity and configured to accommodate different sized electronic devices.

19. The protective housing assembly of claim 16, further comprising a mounting assembly which includes at least one hole in bottom of the housing adapted to be coupled with a head on a mounting pad, the mounting pad configured to be attached to a surface on which the protective housing assembly is to be placed by a user.

20. The protective housing assembly of claim 16, further comprising a mounting assembly which includes at least a mounting docking station adapted to be attached to a surface on which the protective housing assembly is to be placed by a user, wherein the housing is adapted to be mounted on the docking station.
